(19) United States
(12) Patent Application Publication
(10) Pub. No.: US 2011/0191679 A1
(43) Pub. Date: Aug. 4, 2011

(54) System and Method for Online Media Preview

(75) Inventors: Kui Lin, Redwood City, CA (US); Jiangping Feng, Bejing (CN); Yu Huang, Bridgewater, NJ (US); Hong Heather Yu, West Windsor, NJ (US)

(73) Assignee: FutureWei Technologies, Inc., Plano, TX (US)

(21) Appl. No.: 13/018,121

(22) Filed: Jan. 31, 2011

Related U.S. Application Data
(60) Provisional application No. 61/300,641, filed on Feb. 2, 2010.

(51) Int. Cl. G06F 3/01

(52) U.S. Cl. 715/716

(57) ABSTRACT

An embodiment of a system and method for online media preview extracts a plurality of preview frames from a media file. The preview frames are saved in a layered data structure. In addition, the preview frames may be scaled to a lower resolution so that the preview file formed by the preview frames is reduced in size. After receiving a preview request, a delivery scheduling scheme delivers the preview frames at selected time points to minimize startup delay and playback jitter.

This application claims the benefit of U.S. Provisional Application No. 61/300,641, filed on Feb. 2, 2010, entitled “A System for Generating, Distributing, and Presenting Scrub Preview for Online Media Services,” which application is hereby incorporated herein by reference.

### TECHNICAL FIELD

The present invention relates generally to a system and method for online media, and more particularly to a system and method for online media preview.

### BACKGROUND

In typical online media platforms or delivery systems, on-demand media, such as video, audio and other types of multimedia, content is presented via media players that allow users to randomly seek to any spot to continue the video playback. The media content generally is consumed either linearly (by default, for example, by clicking a web thumbnail which leads to a media for playing within a media player) or randomly, by the end user dragging the play-head of media player forward or backward to a random spot. These types of media consumption models generally do not provide the end user effective consumption of media content. The random drag or scrub of the play-head may appear to provide infinite flexibility to the end user, but such dragging to a spot generally involves random guess work, and users often have to watch the content for a short period of time to determine whether to continue from that spot or to perform another random drag operation to locate a different spot in the media.

### SUMMARY OF THE INVENTION

These and other problems are generally solved or circumvented, and technical advantages are generally achieved, by embodiments of the present invention which provides online media preview.

In accordance with an example embodiment of the present invention, a method for online media preview comprises extracting one frame from a segment of a media file as a preview frame, storing a plurality of such preview frames into a plurality of layers and delivering the media file and a plurality of the preview frames to a user. The segment of the media file is selected from the group consisting of a group of pictures, a fixed length of video segment, a fixed length of media stream, and one shot of a video. The preview frame may be scaled to a lower resolution in response to a preview parameter wherein the parameter is selected from the group consisting of a preview window size, playback quality and position spacing between preview frames, and combination thereof. Furthermore, the preview frame may be saved in a hierarchical data structure or a layered data structure.

The method for online media preview further comprises generating a metadata file, generating a manifest file comprising preview description information, generating an index file comprising location information of each preview frame and generating a preview media stream. The index file contains each preview frame's location information in the media file. Moreover, the method for online media preview comprises delivering the plurality of such preview frames at selected time points to reduce startup delay and playback jitter.

In accordance with another example embodiment of the present invention, a system for online media preview comprises a media file and a corresponding preview file which comprises a plurality of frames, each of which is extracted from the media file. The plurality of frames are stored in a layered data structure. If necessary, each frame may be saved a low bitrate format. The system for online media preview further comprises a metadata file, a manifest file, an index file and a preview media stream. The index file contains each frame's location information in the media file.

In accordance with yet another example embodiment of the present invention, a method for online media preview comprises rendering a media file, receiving a preview request from a user, rendering a first layer of a preview file to generate a first-level grain preview and rendering a second layer of the preview file to generate a second-level grain preview. The method for online media preview further comprises receiving a plurality of frames of the preview file in an interleaved format.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a simplified diagram of a system for previewing media;

FIG. 2 illustrates a sample media player diagram;

FIG. 3 illustrates a block diagram of an advanced media preview unit;

FIG. 4 illustrates a layered data structure;

FIG. 5 illustrates one portion of a flow chart in accordance with a preview stream scheduling scheme;

FIG. 6 illustrates the other portion of the flow chart shown in FIG. 5;

FIG. 7 illustrates an interleaved delivery scheduling scheme; and

FIG. 8 illustrates a simplified block diagram of a computer system that can be used to implement the advanced media preview method in accordance with an embodiment.

### DETAILED DESCRIPTION

The making and using of the presently embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely generating, distributing and presenting online video preview. The invention also may be applied, however, to preview for other types of multimedia, such as audio, and to other content locations, such as local or non-online content.

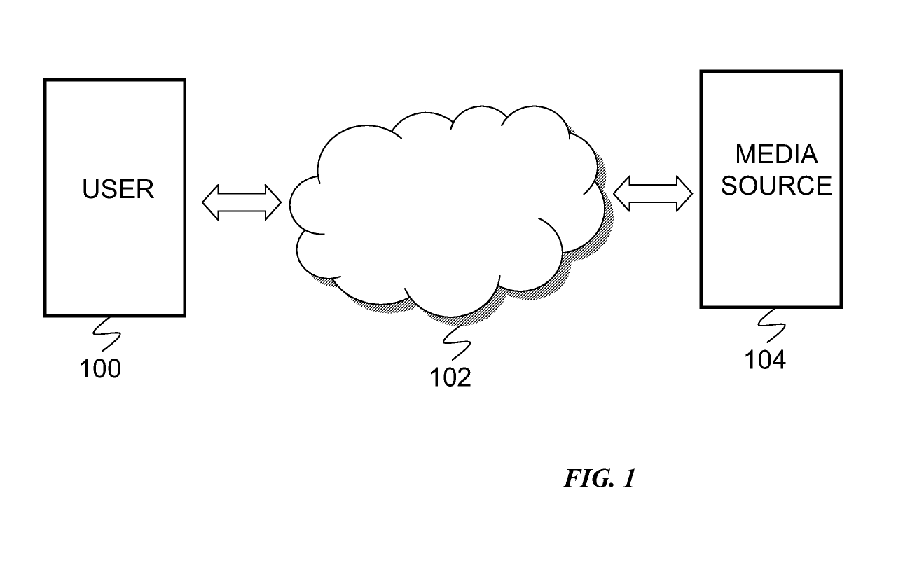

FIG. 1 illustrates a simplified diagram of a system for previewing media. The embodiment architecture shown in FIG. 1 comprises a user 100, a network 102 and a media source 104. The user 102 may be a display device capable of receiving and storing media content from the media source 104 via the network 102. Furthermore, the user 100 is capable of rendering the media content via its display.

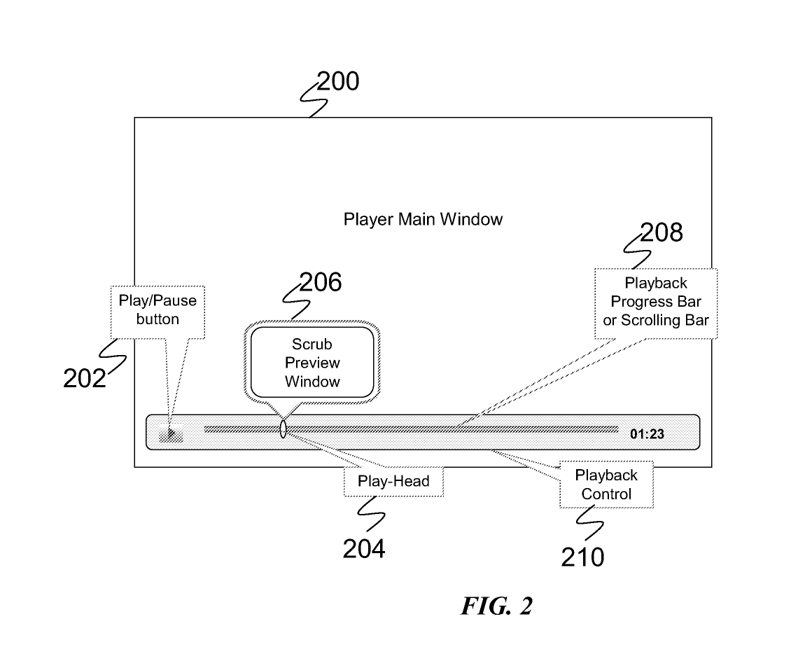

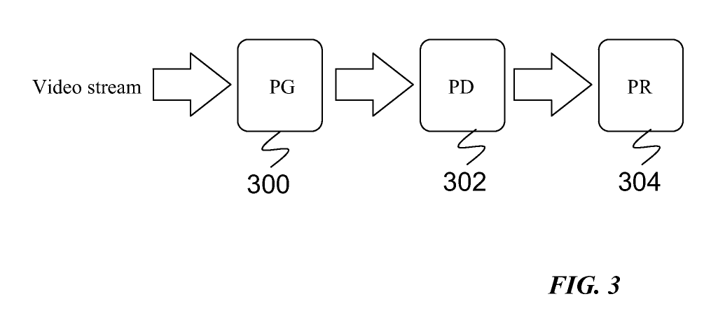

The user 100 may randomly drag any portion of the media (i.e., drag of play-head in a player to seek for a more desirable spot to continue). An advanced media preview unit (illustrated in FIG. 3) extracts a plurality of frames from a media file and creates a preview media stream. In response to a preview request from a user, the advanced media preview unit provides the user 100 a series of preview images (or even lower resolution video clips) when the user 100 drags the play-head along a progress bar of the user's display (illustrated in FIG. 2). The advanced media preview unit enhances active media consumption needs by allowing the user 100 to search for and find a preferred spot to continue the media consumption, and hence greatly improves the end user media consumption experience.

Some existing systems, such as YouTube, provide a limited preview functionality application. In the current YouTube players, the preview is limited to the already downloaded portion of the video which may be only a very small percentage of the entire video. Embodiments of the invention extend preview capability by providing a scrub preview function that expands the preview to the entire video, not just the downloaded portion of the video. This improvement may greatly enhance users' ability to browse the on-demand video before, during, and after the playback of the video. Embodiments include systems and methods to realize scrub preview in a networked media distribution system with an online media player. Other embodiments include a layered data structure, a delivery schedule scheme, and a frame alignment scheme that facilitate scalable delivery and scalable rendering for an optimum user experience.

FIG. 2 illustrates a sample media player diagram. As shown in FIG. 2, a sample media player 200 is shown to indicate the typical media player components and their relative positions in the media player. Of course, the arrangement and relative sizes and proportions of the components may be varied in different embodiments. In accordance with an embodiment, the media player 200 comprises a play control panel 210. The play control panel 210 further comprises a play/pause button 202 on its left side and a preview bar 208 on its right side. The diagram shows a reduced size scrub preview window 206 whose size may vary from small to full player window size depending on application needs. When a media player user initiates a scrub preview, the user drags a play-head 204 forward or backward along the preview bar 208. It should be noted that the preview bar 208 may be the playback progress bar, or it may be a separate bar. The granularity of the preview is in general proportion to the length of the video. To offer a personalized experience, however, a scalable preview rendering function can be realized using embodiments of the present invention. Furthermore, a localized scalable preview rendering capability can be achieved where the scalability of the preview is proportional to the play-head dragging speed with locality sensitivity. Users can easily browse through a video from the beginning to the end or back and forth. A user can also start the playback instantly at any preview position and start to watch the video thereafter. The preview stream delivery scheme enhances the video preview start up time and provides preview playback without glitches.

FIG. 3 illustrates a block diagram of an advanced media preview unit. Upon receiving a media stream, the advanced media preview unit is configured to perform the following processes to support scrub preview. As shown in FIG. 3, the advanced media preview unit extracts a plurality of preview frames and generates a preview media file in a preview generation process 300. After the preview media file is generated, the advanced media preview unit delivers the preview media file to a user through a preview delivery process 302. At a user side, through a plug-in module, the advanced media preview unit performs a preview rendering process 304. It should be noted that while FIG. 3 illustrates the advanced media preview unit is capable of performing three preview processes, namely preview generation, preview delivery and preview rendering, the advanced media preview unit at a media source may only comprise the preview generation process and the preview delivery process. The preview rendering process may be executed by a media player via the communication between the media player and the advanced media preview unit. Furthermore, the media player may have a plug-in module through which the media player can substitute the rendering function of the advanced media preview unit.

The preview generation process 300 is configured to extract and prepare preview media data and metadata (e.g., manifest file or index file to facilitate delivery) used for effective delivery and rendering. In a media file management system, an ingest process is a process in which media files and corresponding metadata are acquired and saved into the media file management system. The preview generation process 300 may occur either during an ingest process or after the ingest process but before the media content is delivered from the media file management system to an end user. It should be noted that the preview generation process 300 may generate additional media data and metadata beyond the existing media and metadata in order to support the media preview feature.

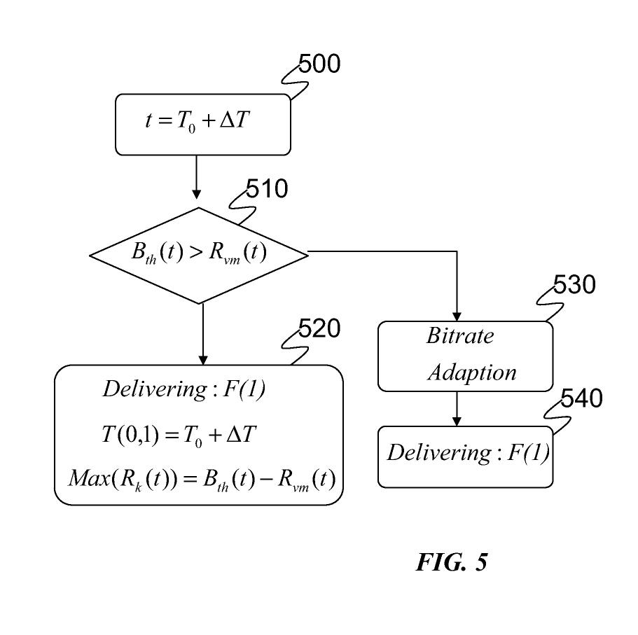

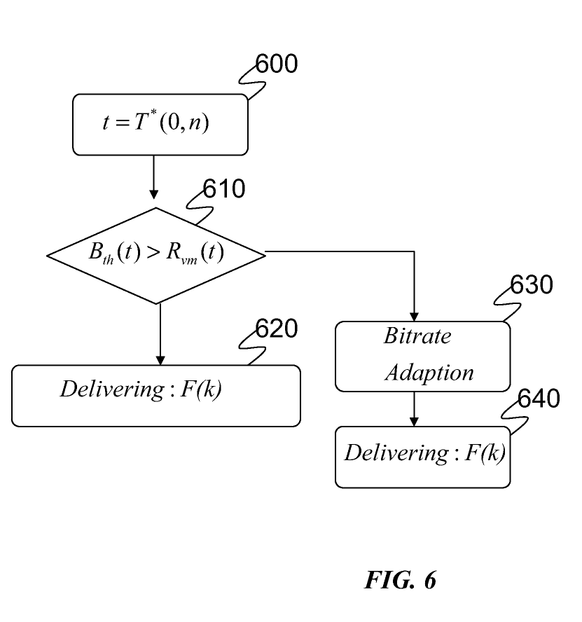

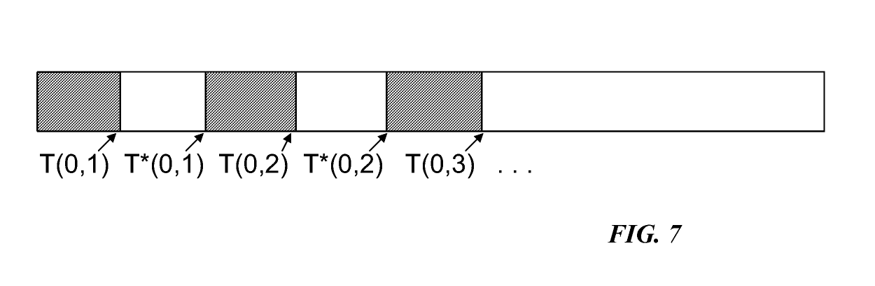

The preview delivery process 302 includes a process wherein preview media data and metadata are delivered to the end user media player for preview rendering. The detailed methods of when and how to deliver which preview data file(s) will be described with respect to FIG. 5, FIG. 6 and FIG. 7.

The preview rendering process 304 is a process by which delivered preview data files are rendered to the end user as play-head is being dragged to seek a desired position. The preview rendering process 304 is sufficiently general so that it can be implemented easily by any player with a simple plug-in module.

Referring to FIG. 3 again, a typical preview generation process 300 comprises extracting preview media data, generating metadata, creating manifest files and index files and creating a preview media stream.

To facilitate full video preview and fast preview start up, it is desirable that the preview media data stream is small in size such that delivery of the preview media data stream will not significantly hinder the delivery of the original media data stream or affect the playback experience of the original media data stream. To achieve that, many schemes can be employed. In a first embodiment, one keyframe per segment may be extracted. A segment may be one group of pictures (GOP) in Moving Picture Experts Group (MPEG) formatted video, a fixed length of video segment of the media stream, one shot of a video, or it may be defined in any way that facilitates the extraction of keyframes to create the preview media data stream. To further reduce the preview file size and delivery bandwidth requirement, a scaled version of the keyframes may be extracted. The scale, i.e., the resolution and bitrate of the keyframes may be decided based on the preview window size, the playback quality requirements, and the position spacing between preview key-frames, etc. To support a scalable preview rendering functionality, the keyframes may be organized in a hierarchical or layered data structure. A layered data structure and packaging scheme to facilitate personalized and instantaneous preview experience is described hereinafter.

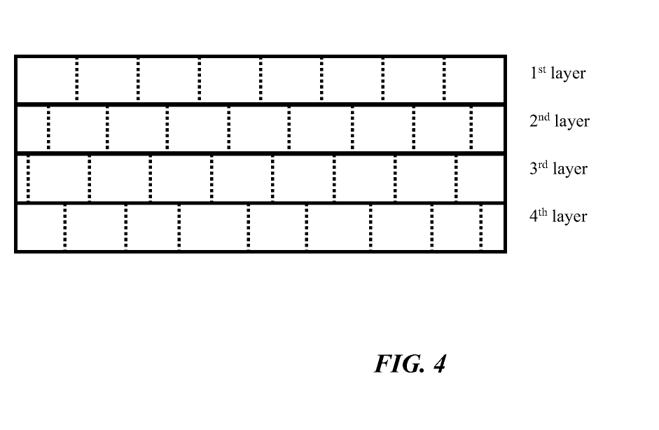

In accordance with an embodiment, the number of keyframes of a full preview media stream is Nm, the length of the scrolling bar is Lm, and the number of layers of keyframes is K. The layered structure of key frames is constructed as follows. For ease of illustration, the number of keyframes in the following sample embodiment is approximately identical. That is the number of keyframes Nk in the kth layer is approximately Nm/K. Starting from the first segment S(1), the keyframe of segment S(i) is clustered into layer k if i mod K=k. An example of four-layer preview media stream is illustrated in FIG. 4, in which the dashed lines correspond to key frame locations in the video and there are 8 key frames in each layer in this case. It should be noted that one of skill in the art can easily modify this such that each layer is defined with a different number of keyframes.

The keyframes of different layers may be saved in the same file or different files depending on different configuration requirements. Once the preview media data is extracted, the corresponding metadata, i.e., the description data to describe the preview media data can be generated at this time and the manifest file and an index file to facilitate scrub preview are generated. The index file lists the data structure of the preview media data stream as well as the keyframe locations in the original media data stream. The manifest file, serving as the preview media data description file, may comprise different description and metadata to facilitate different uses of the scrub preview. For instance, the preview files location, the overall metadata, such as title, genre, and producer information, and some scene description information, annotations, etc. can be included in the manifest file. Although in one embodiment the manifest file is packaged separately from the preview media data file, in another embodiment, it could be packaged into the same file as the preview media data file.

With the index file, a player can easily and quickly allocate the scrub preview media data. In some cases, it also helps to conserve resources such as bandwidth and memory. In this case, the preview media data stream is not actually extracted from the original media stream or saved in a separate file. Instead, the index file indicates explicitly the location of the keyframes for the player to extract in real time from the original media stream for scrub preview. Notice that this embodiment is best suited for certain application scenarios where real time extraction is easily achievable and cost effective.

To ensure glitch-free playback at any preview point, preview frame alignment may be used. To do that, the corresponding location of each keyframe in the original media data stream is registered in the index file and used for preview rendering.

In the preview generation process 300, the preview media data file is generated through extracting frames from the original media file. Upon receiving a preview request from an end user, the preview delivery process 302 delivers preview media data and metadata to the end user. A sample embodiment of preview delivery with an emphasis on the preview stream scheduling scheme is discussed below. A multi-step delivery scheme that takes advantage of the aforementioned packaging and scheduling algorithms to ensure preview quality of experience (QoE) is also described.

Assume T0 is the time when a video stream Vm is being delivered from the edge server to the client for playback, AT is the minimum buffer length for the player to start video playback, T(i,k) is the time when the ith chunk of the kth layer preview keyframes starts to be delivered, and T*(i,k) is the time when the ith chunk of the kth layer preview keyframes delivery is ended. Let Bth(t) denote the available bandwidth between the server and the client for content delivery at time t, Rp(t) denote the media player playback bitrate for Vm at time t, Rvm(t) denote the minimum delivery bitrate of Vm at time t to prevent playback jitter at the client, Rk(t) denote the delivery bitrate of the keyframe stream at time t, and KF(n,k) denote the nth keyframe of the kth layer preview keyframe.

In the following sample embodiment, we assume different layers of the keyframes are packaged in different files where F(k) denotes the kth layer preview file. One skilled in the art can easily modify the embodiment such that different layers of keyframes are packaged in a single preview file. Generally, ΔT is governed by many factors, such as the GOP size of a compressed video. Based on the many references available in the field, one skilled in the art can calculate AT based on the specific application requirement.

FIG. 5 illustrates one portion of a flow chart in accordance with a preview schedule scheme. At step 500, a video stream Vm is being delivered from the edge server to the client for playback, where ΔT is the minimum buffer length for the player to start video playback. At step 510, if Bth(t)>Rvm(t), then the algorithm executes step 520 wherein the algorithm starts delivering F(1) and set T(0,1)=T0+ΔT, Max(Rk(t))=Bth(t)−Rvm(t), (case A). On the other hand, if Bth(t)<Rvm(t), the algorithm executes step 530 wherein the algorithm performs bitrate adaption and delivers F(1) subsequently.

FIG. 6 shows the other portion of the flow chart illustrated in FIG. 5. At step 600, the algorithm finishes keyframe delivery of the first layer preview file. At step 610, if Bth(t)>Rvm(t), then the algorithm executes step 620 wherein the algorithm starts delivering F(k), k=2,3, . . . , n. On the other hand, if Bth(t)<Rvm(t), the algorithm executes step 630 wherein the algorithm performs bitrate adaption and delivers F(k) subsequently.

In accordance with an embodiment, F(1) may be delivered as soon as Vm starts being delivered. In accordance with another embodiment, F(1) may be delivered before Vm starts being delivered. However, in most applications, Vm starts being delivered as soon as possible such that minimum of startup delay may be introduced. In accordance with yet another embodiment, some or all of F(k) (k=1,2 . . . ) may be delivered from a different server or a peer client. When the original server down stream bandwidth is constrained and becomes a bottleneck, such scheme can help to reduce server congestion and improve user QoE.

It should be noted that while FIGS. 5 and 6 illustrate a control algorithm for delivering preview media data, a person having ordinary skill in the art will recognize many alternatives. FIG. 7 illustrates an interleaved delivery scheduling scheme. When an interleaved delivery scheduling scheme is employed, the following criteria generally is satisfied: Rp(t)≦Rvm(t)*(T*(0,j)−T(0,j))/(T*(0,j+1)−T*(0,j))/ where T*(0,j=0)=T0.

Although only one preview layer k is assumed, and F(k) is delivered between T(0,j) and T*(0,j) in the above listed sample embodiments, one skilled in the art will understand that F(k) can also be a super file with multiple preview layers or a partial layer of a preview layer. In either case, similar scheduling scheme can be used.

It should be noted that while FIGS. 5, 6 and 7 illustrate two algorithms for delivering preview media data, the algorithms in FIGS. 5, 6 and 7 are for illustrative purposes only. A person having ordinary skill in the art would recognize that many fast startup algorithms can be used in conjunction with the proposed scheme without sacrificing the QoE.

After preview media data and metadata are delivered to an end user, the preview view rendering process renders preview data files to the end user. In the following sample embodiment, the preview keyframes are packaged based on location in the preview data structure. That is, keyframes in different layers are packaged in different files. Again, one skilled in the art can easily modify the embodiment such that those keyframes are packaged into a single file or one layer of keyframes is packaged into multiple files. In a first step, a media player gets the manifest file and extracts the layered preview files location. Then, in a second step, the media player downloads the first layer preview file. In a third step, the media player downloads the second layer preview file. The media player repeats similar downloading until the media player downloads the kth layer preview file.

The media player does not always need to download all the preview files describe in the manifest file. The number k is decided by the length of the preview scroll bar and the video length. For a specific video, longer preview scrolling bar can sustain finer grain mouse movement. Hence more preview keyframes and thus more preview files may be downloaded for a scalable preview experience. It is conceivable that within a single media player session, an end user may toggle between full screen display mode and regular screen display mode of a given media player. This action will change the scroll bar length, and therefore may call for an accelerated downloading of the additional preview media data layers (files) in order to accommodate this model change (i.e., a switch to full screen display mode).

With a first layer preview file, a user can get a coarse grain preview experience. After getting the following layers of preview files, the user can enjoy finer grain preview experiences. The more layers of preview files being downloaded, the better granularity the scrub preview will provide, and the better preview experience can be achieved.

Once the video begins to playback, the media player checks the available bandwidth to compute if it is possible to download a preview file and meanwhile keep the video playing back smoothly. The media player periodically checks the network condition until the needed preview files are all downloaded. The scrub preview function generally will not be enabled until at least one preview file is downloaded.

To facilitate instant playback from any scrub preview point, i.e., to playback the video from any scrub preview keyframe, the media player obtains the original media data location info of the keyframes from the index file. It then compares the location with the buffer. If the location runs outside of the buffer, it communicates with the edge server immediately to acquire the corresponding media segments from the original media data stream to facilitate instant startup.

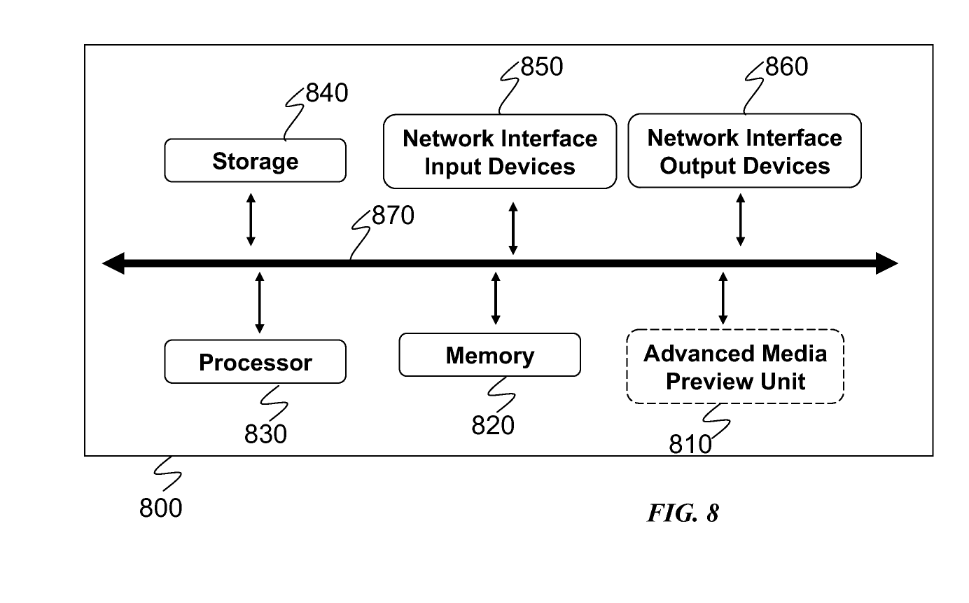

FIG. 8 illustrates a simplified block diagram of a computer system 800 that can be used to implement the advanced media preview method in accordance with an embodiment. The computer system 800 includes an advanced media preview unit 810, a memory 820, a processor 830, a storage unit 840, network interface input devices 850, network interface output devices 860 and a data bus 870. It should be noted that this diagram is merely an example of a personal computer, which should not unduly limit the scope of the claims. Many other configurations of a personal computer are within the scope of this disclosure. One of ordinary skill in the art would also recognize the advanced media preview method may be performed by other computer systems including a portable computer, a workstation, a network computer, or the like.

The advanced media preview unit 810 may be a physical device, a software program, or a combination of software and hardware such as an Application Specific Integrated Circuit (ASIC). In accordance with an embodiment, when the computer receives a media file through the network interface input devices 850, the processor 830 loads the media file into the storage unit 840. According to an embodiment where the advanced media preview method is implemented as a software program, the process 830 loads the software program from the storage unit 840 and operates it in the memory 820. After the processor 830 performs the steps of FIG. 3, the processor 830 sends the preview results to the end user through a network interface output devices 860.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
extracting one frame from a segment of a media file as a preview frame;
storing a plurality of such preview frames into a plurality of layers; and
delivering the media file and a plurality of the preview frames to a user.

2. The method of claim 1, wherein the segment is a media element selected from the group consisting of a group of pictures, a fixed length of video segment, a fixed length of media stream, and one shot of a video.

3. The method of claim 1, wherein the preview frame is scaled to a lower resolution in response to a preview parameter wherein the parameter is selected from the group consisting of a preview window size, playback quality and position spacing between preview frames, and combination thereof.

4. The method of claim 1, wherein the preview frame is saved in a hierarchical data structure.

5. The method of claim 1, wherein the preview frame is saved in a layered data structure.

6. The method of claim 1, further comprising:
generating a metadata file;
generating a manifest file comprising preview description information;
generating an index file comprising location information of each preview frame; and
generating a preview media stream.

7. The method of claim 6, wherein the index file contains each preview frame's location information in the media file.

8. The method of claim 1, further comprising delivering the plurality of such preview frames at selected time points to reduce startup delay and playback jitter.

9. A system comprising:
a media file; and
a corresponding preview file comprising a plurality of frames, each of which is extracted from the media file.

10. The system of claim 9, wherein the plurality of frames are stored in a layered data structure.

11. The system of claim 9, wherein each frame is saved in a low bitrate format.

12. The system of claim 9, further comprising:
a metadata file;
a manifest file;
an index file; and
a preview media stream.

13. The system of claim 12, wherein the index file contains each frame's location information in the media file.

14. A method comprising:
rendering a media file;
receiving a preview request from a user;
rendering a first layer of a preview file to generate a first-level grain preview; and
rendering a second layer of the preview file to generate a second-level grain preview.

15. The method of claim 14, further comprising receiving a plurality of frames of the preview file in an interleaved format.

16. A computer program product having a non-transitory computer-readable medium with a computer program embodied thereon, the computer program comprising:
computer program code for extracting one frame from a segment of a media file as a preview frame;
computer program code for storing a plurality of such preview frames into a plurality of layers; and
computer program code for delivering the media file and a plurality of the preview frames to a user.

17. The computer program product of claim 16, further comprising:
computer program code for rendering a media file;
computer program code for receiving a preview request from the user;
computer program code for rendering a first layer preview file to generate a first grain preview; and
computer program code for rendering a second layer preview file to generate a second grain preview.

18. The computer program product of claim 16, further comprising:
computer program code for generating a metadata file;
computer program code for generating a manifest file comprising preview description information;
computer program code for generating an index file comprising location information of each preview frame; and
computer program code for generating a preview media stream.

19. The computer program product of claim 16, further comprising computer program code for performing bit rate adaption when the preview frames are delivered to the user.

20. The computer program product of claim 16, further comprising computer program code for extracting frames from the media file and saving the frames in a layered data structure.
